(19) United States
(12) Patent Application Publication
(10) Pub. No.: US 2025/0128626 A1
(43) Pub. Date: Apr. 24, 2025

(54) METHODS, SYSTEMS, AND DEVICES FOR INDUCTICTIVE CHARGING OF VEHICLE BATTERIES

(71) Applicant: ENERSYS DELAWARE INC., Reading, PA (US)

(72) Inventors: Nicolas Métivet, Doullens (FR); Antoine Hombert, Croisilles (FR); Brahim Azzabi Zouraq, Arras (FR); Patrick Chris Dehem, Vitry-en-Artois (FR)

(21) Appl. No.: 18/682,609

(22) PCT Filed: Aug. 11, 2022
(86) PCT No.: PCT/US2022/074796

§ 371 Date: Feb. 9, 2024

(30) Foreign Application Priority Data
Aug. 12, 2021 (EP) 21306116.1

(51) Int. Cl. B60L 53/39; B60L 53/122; B60L 53/65; B60L 53/66; H02J 50/10; H02J 50/40; H02J 50/80; H02J 50/90

(52) U.S. Cl. CPC B60L 53/39; B60L 53/122; B60L 53/65; B60L 53/66; H02J 50/10; H02J 50/402; H02J 50/80; H02J 50/90

(57) ABSTRACT

Methods, systems, and devices for transferring energy and communications signals via inductive coupling to an on-board coil of an electric vehicle. As an example, a charging apparatus may include a plurality of power transfer coils; and a controller, configured to: detect a presence of the vehicle in a proximity of the charging apparatus; identify a power transfer coil from the plurality of power transfer coils to activate based on a position of the vehicle relative to the charging apparatus: and activate the identified power transfer coil.

### CROSS-REFERENCE TO RELATED APPLICATION

The present application claims the benefit of priority to European Patent Application No. 21306116.1, filed on Aug. 12, 2021, and the entire contents of the above-identified application are incorporated by reference as if set forth herein.

### TECHNICAL FIELD

The present disclosure relates to the electric charging of vehicles, and in particular, to methods, systems, and devices for charging vehicle batteries using inductive charging.

### BACKGROUND

Batteries have become increasingly important, with a variety of industrial, commercial, and consumer applications. Of particular interest are power applications involving “deep discharge” duty cycles, such as motive power applications. The term “deep discharge” refers to the extent to which a battery is discharged during service before being recharged. By way of counter example, a shallow discharge application is one such as starting an automobile engine wherein the extent of discharge for each use is relatively small compared to the total battery capacity.

There is significant and increasing interest in consumer and commercial electric vehicles (EVs) that are propelled using electric motors supplied with power from “deep discharge” electric batteries. Examples of EVs include, but are not limited to, cars, vans, trucks, tractor units for semi-trailer trucks, sport utility vehicles (SUVs), airborne vehicles, and seaborne vehicles. Additional motive power applications that require deep discharge capability include Class 1 electric rider trucks, Class 2 electric narrow aisle trucks and Class 3 electric hand trucks. Purchasing trends and consumer surveys suggest that EVs may account for over 20% of the global vehicle market by 2030, with even higher adoption rates in some regions and countries.

The electric batteries in EVs are typically lithium-ion and lithium polymer, which offer high energy density compared to their weight. Other types of rechargeable batteries used in EVs include lead-based batteries and nickel-based batteries, as examples.

Many currently available EVs are charged using a plug or other wired connector. For example, some EVs can be coupled to standard electrical sockets via a supply cable, and an on-vehicle converter may convert alternating current (AC) grid power supplied from the socket into direct current (DC) power to charge the battery. Some EVs may be charged using an external charger that converts the AC grid power into the DC battery supply power. These chargers may integrate a large AC-to-DC converter capable of supplying a higher amount of power (e.g., a higher voltage and/or current), reducing charging times. Various proprietary and open standards for implementing charging stations and charging cables are available or are being developed to increase the available infrastructure for charging EVs.

Some drawbacks of plug-in charging of EVs stems from the use of relatively thick cables, which may include a relatively large amount of conductive material to deliver the higher voltages and charges, as well as a relatively large amount of insulating material (e.g., cable jacket) to protect the user from electrical shock. These cables can be bulky or difficult to manipulate for some users, and may also be a source of electrical losses. Despite the safety protections, possible electrical shock to a user may result from using these cables. Insertion and removal of the connector may result in mechanical wear, which may necessitate frequent repair and/or replacement of the cable.

### SUMMARY

Aspects of the present disclosure provides methods, systems, and devices that may be used in transferring energy to a vehicle, such as an electric vehicle.

According to some aspects, a charging apparatus configured to transfer energy via inductive coupling to an on-board coil of a vehicle may be provided, the charging apparatus comprising a plurality of power transfer coils; and a controller, configured to: detect a presence of the vehicle in a proximity of the charging apparatus; identify a power transfer coil from the plurality of power transfer coils to activate based on a position of the vehicle relative to the charging apparatus; and activate the identified power transfer coil.

The controller may be configured to identify an power transfer coil from the plurality of power transfer coils to activate based on an activation of each power transfer coil of the plurality of power transfer coils of the charging apparatus in a sequence and based on feedback indicating characteristics of an energy transfer resulting from the activation of each power transfer coil in the sequence.

The charging apparatus may include a plurality of sets of alignment coils, each set of alignment coils associated with a respective one of the plurality of power transfer coils, wherein the controller is configured to identify a power transfer coil from the plurality of power transfer coils to activate based on a detection of alignment signals by each of the alignment coils.

The controller may be configured to detect the presence of the vehicle in the proximity of the charging apparatus based on a signal received from a positioning device.

The controller may be configured to detect the presence of the vehicle in the proximity of the charging apparatus based on a signal received from a component of the vehicle. The signal received from the component of the vehicle may be a signal acknowledging an identification signal transmitted by the charging apparatus.

A center of each of the plurality of power transfer coils may be offset from a center of a housing of the charging apparatus. A housing of the charging apparatus is or resembles a parking bumper.

According to some aspects, a charging apparatus configured to transfer energy via inductive coupling to an on-board coil of a vehicle may be provided. The charging apparatus may include an power transfer coil; a plurality of alignment coils; and a controller, configured to: detect a presence of the vehicle in a proximity of the charging apparatus; detect signals received by each of the plurality of alignment coils; and determine whether the vehicle is aligned or is not aligned relative to the power transfer coil based on the signals received by each of the plurality of alignment coils.

The controller may be configured to detect the presence of the vehicle in the proximity of the charging apparatus based on a signal received from a component of the vehicle. The signal received from the component of the vehicle may be a signal acknowledging an identification signal transmitted by the charging apparatus.

In some embodiments and aspects, the plurality of alignment coils may include at least five alignment coils. The controller may be configured to determine whether the vehicle is aligned or is not aligned relative to the power transfer coil in a first axis, and the controller may be configured to determine whether the vehicle is aligned or is not aligned relative to the power transfer coil in a second axis.

The controller may be configured to determine whether the vehicle is aligned or is not aligned relative to the power transfer coil in one or more horizontal axes, and the controller may be configured to determine whether an airgap between the vehicle and the power transfer coil is present in a vertical axis.

In some embodiments and aspects, the power transfer coil is a first power transfer coil of a plurality of power transfer coils, the plurality of alignment coils is a first plurality of alignment coils of multiple pluralities of alignment coils, each of the plurality of alignment coils associated with a respective one of the plurality of power transfer coils, and the controller is configured to identify a power transfer coil from the plurality of power transfer coils to activate based on a detection of alignment signals by each of the alignment coils of the multiple pluralities of alignment coils.

According to some aspects, a charging apparatus may include a power transfer coil configured to transfer energy to an on-board coil of a vehicle via a resonant signal; a data reception coil configured to receive a communication signal from a coil of the vehicle and the resonant signal from the power transfer coil; and a data reception signal processing circuit configured to separate the communication signal from the resonant signal and provide the separated communication signal to a controller.

In some embodiments and aspects, the data reception signal processing circuit comprises a band-pass filter, an envelope filter, and a low-pass filter.

In some embodiments and aspects, the data reception signal processing circuit is configured to convert the communication signal from an analog signal to a digital signal.

In some embodiments and aspects, the controller is configured to transmit a message to the on-board coil of the vehicle via a signal emission coil.

### BRIEF DESCRIPTION OF THE FIGURES

The accompanying drawings, which are incorporated in and constitute a part of the specification, illustrate embodiments of the inventive concepts and, together with the description, serve to explain principles of the inventive concepts.

FIGS. 1A-C illustrate example EV charging systems that uses inductive charging, according to some aspects of the present disclosure.

FIGS. 2A-B illustrate aspects of misalignment and airgap problems in inductive charging systems.

FIGS. 3A-B illustrate some components of a charging apparatus that may be used in EV charging systems, according to some aspects of the present disclosure.

FIGS. 4A-B illustrate examples of transferring energy despite a misalignment and/or airgap between components of inductive charging systems that include the charging apparatus of FIGS. 3A-B, according to some aspects of the present disclosure.

FIGS. 5A-B illustrate example EV charging systems that uses inductive charging, according to some aspects of the present disclosure.

FIGS. 6-7 are flowcharts illustrate operations within a method of charging an EV using the charging apparatus of FIGS. 3A-B, according to some aspects of the present disclosure.

FIGS. 8A and 8B illustrate some components of charging apparatuses that may be used in EV charging systems, according to some aspects of the present disclosure.

FIGS. 9A-B illustrate examples of detecting misalignments and/or airgaps in inductive charging systems that include the charging apparatus of FIGS. 8A and 8B, according to some aspects of the present disclosure.

FIGS. 9-10 are block diagrams to describe in greater detail some of the components of the charging apparatuses of FIGS. 8A and 8B, according to some aspects of the present disclosure.

FIG. 12 is a flowchart illustrating operations within a method of charging an EV using the charging apparatus of FIGS. 8A and 8B, according to some aspects of the present disclosure.

FIG. 13 illustrates a charging apparatus that may be used in EV charging systems, according to some aspects of the present disclosure.

FIG. 14 is a flowchart illustrating operations within a method of charging an EV using the charging apparatus of FIG. 13, according to some aspects of the present disclosure.

FIGS. 15A-15B are flowcharts illustrate operations within a method of charging an EV using the charging apparatuses of FIGS. 3A-B, FIG. 8A, or FIG. 13, according to some aspects of the present disclosure.

FIG. 16 is a block diagram illustrating aspects of a computing device that may be used or implemented according to aspects of the present disclosure.

### DETAILED DESCRIPTION

In addition to the plug-in charging discussed above, inductive wireless charging technologies are also being considered and developed for EVs. Inductive wireless charging may address some of the problems discussed above with respect to charging cables. Inductive charging uses electromagnetic fields to transfer energy through inductive coupling from an off-board source (e.g., a charger station or pad) to an on-board destination (e.g., a charging circuit on the vehicle). This inductive coupling may be resonant inductive coupling, which may result in more efficient power transfer.

In inductive charging, AC may pass through a primary coil present in the off-board charging station or pad. This alternating current creates a fluctuating magnetic field as it moves through the primary coil, which in turn induces an alternating electric current in an on-board (secondary) induction coil. The on-board AC can then be passed through a rectifier to convert it to DC, which is then used to charge the on-board battery. The off-board source may be referred to herein interchangeably as an off-board coil, a primary coil, or a sender coil, and the on-board destination may be referred to herein interchangeably as an on-board coil, a secondary coil, or a receiver coil.

In EVs equipped with an inductive charger, the plug-in cord may no longer be required. To initiate charging, the EV may be placed or parked relatively close to the off-board source. Although inductive charging technology provides some advantageous benefits over plug-in charging, misalignment of the off-board coil and on-board coil or an airgap therebetween may result in a considerable reduction of the efficiency of the charge.

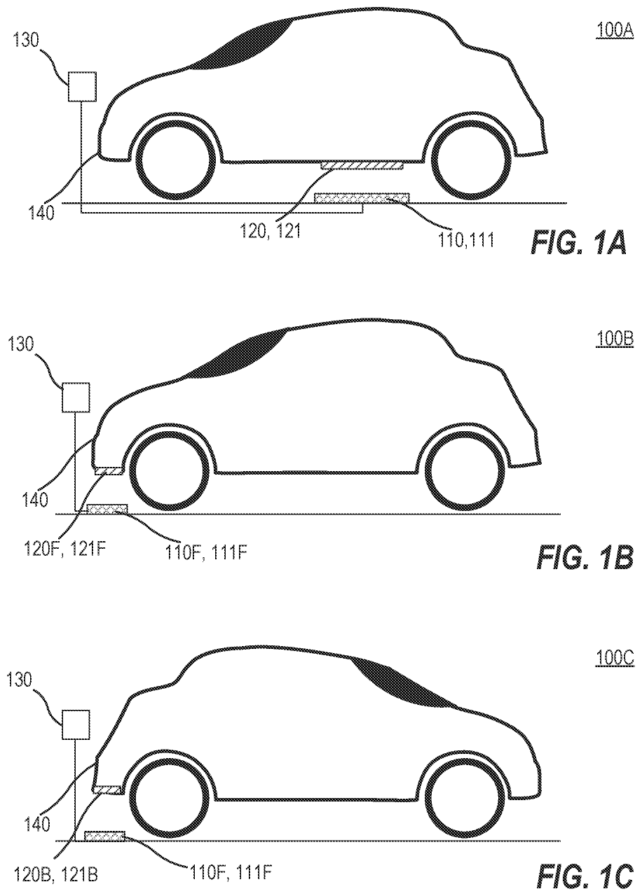

FIG. 1A illustrates one example EV charging system 100A that uses inductive charging. An EV 140 may be equipped with an on-board inductive charging system 120 that includes an on-board coil 121 on the underside or ground-facing side of the EV 140. The on-board coil 121 may be positioned on the underside or ground-facing side of the EV 140 between the front and rear wheels of the EV 140, and/or at a central portion of the EV 140. The on-board inductive charging system 120 and the on-board coil 121 thereof may be coupled to additional circuitry and/or to a battery not shown in the figure.

An off-board inductive charging system 110 may be installed at a parking location at which the EV 140 can be placed or parked. An example parking location may be a parking spot, garage stall, designated charging area, or the like. The off-board inductive charging system 110 includes an off-board coil 111, which may be installed on or in a floor or ground of the parking location. The off-board coil 111 may be positioned in a central portion of the parking location such that it will be aligned with the on-board coil 121 positioned on the underside or ground-facing side of the EV 140. The off-board inductive charging system 110 and the off-board coil 111 thereof may be coupled to circuitry and/or to the main grid or other energy source not shown in the figure.

A controller 130 is also present in the EV charging system 100A and may be used by a user to initiate charging of the EV 140 (i.e., initiate a transfer of energy through inductive coupling of the off-board coil 111 and the on-board coil 121) and perform other actions with respect to the EV charging system 100A. For example, the controller 130 may be used to provide payment information as part of purchasing charging services of the EV 140, subscriber information as part of indicating a user or subscriber of charging services of the EV 140, or other information that may be used to facilitate charging of the EV 140. Although the controller 130 is shown as a component of the EV charging system 100A that is separate from the off-board inductive charging system 110, in some embodiments the controller 130 may be integrated into the off-board inductive charging system 110. In some embodiments, the controller 130 may communicate (e.g., via radio frequency (RF) signals) with the EV 140 or an electronic device associated with the EV 140, such as a smartphone or other electronic device of the user.

Although the placements in FIG. 1A of the off-board coil 111 in the central portion of the location where the EV 140 is parked and the on-board coil 121 on the central portion of the underside or ground-facing side of the EV 140 provide some benefits, the present disclosure is also based in part on recognition of some of the drawbacks thereof. Variations in different types of vehicles, such as their length and width, can make it difficult to determine where to place the off-board coil 111 of the off-board inductive charging system 110. A large SUV may have substantially different dimensions than a small coupe or sedan, and accordingly achieving good alignment of the off-board coil 111 with different on-board coils 121 located at different positions on their respective EVs 140 may be difficult. In some instances, placements of the off-board coil 111 in the central portion of the parking location can cause structural issues, such as in multi-level parking garages. Installation of an off-board coil 111 can also be very expensive, especially when installed within the floor surface of the parking location.

FIGS. 1B and 1C illustrate EV charging systems 100B and 100C with

alternative placements of the off-board coil and the on-board coil according to aspects of the present disclosure. In FIG. 1B, the on-board coil 121F may be located at a front portion or front bumper of the EV 140, and in FIG. 1C, the on-board coil 121B may be located at a rear portion or rear bumper of the EV 140. The off-board coil 111F may be located at a front portion of the parking location. In some embodiments, a parking bumper may be used as a support for the off-board coil 111F.

The placement of the on-board coils 121F/121B and off-board coil 111F in EV charging systems 100B and 100C may address some of the issues of the EV charging system 100A. For example, many parking locations have bumper structures at the front portion of the parking location, and thus installing the off-board inductive charging system in a new parking location or retrofitting an existing parking location may be easier. Additionally, integrating the off-board coil 111F in the parking bumper or other raised structure may improve coupling efficiency between the on-board coils 121F/121B and off-board coil 111F.

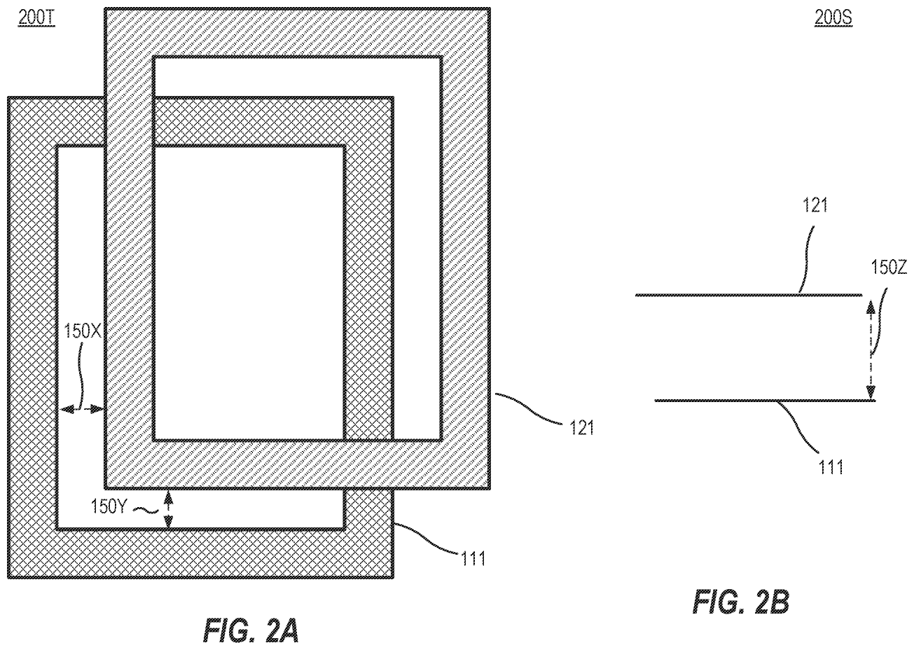

On the other hand, misalignments and airgaps may occur in the EV charging systems 100B and 100C of FIGS. 1B and 1C, as in the EV charging systems 100A of FIG. 1A. Examples of misalignments and an airgap are illustrated in FIGS. 2A and 2B. FIG. 2A is a top view 200T of an on-board coil 121 and an off-board coil 111. FIG. 2B is a side view 200S of the on-board coil 121 and the off-board coil 111. The shape and dimensions of the on-board coil 121 and off-board coil 111 have been selected and/or exaggerated for clarity.

As can be seen, a misalignment may occur in one or both horizontal axes, resulting in a first axis (or X-axis) misalignment 150X, or a second axis (or Y-axis) misalignment 150Y. The misalignment on the first axis or second axis may be referred to herein as a horizontal misalignment. There may also be an excessive vertical (or Z-axis) distance between the off-board coil 111 and the off-board coil 121. (or Z-axis) This excessive vertical distance may be referred to herein as an airgap 150Z. A horizontal misalignment or vertical airgap in one or more axes of the on-board coil 121 and the off-board coil 111 may reduce an efficiency in the transfer of energy from the off-board coil 111 to the on-board coil 121, and in some situations the misalignment or airgap may be severe enough so as to prevent the transfer of energy. These misalignments or airgap may occur because the EV 140 is not well-positioned in the parking location, for example because of a user error in positioning the EV 140, because a vehicle in an adjacent location being poorly positioned, or because the on-board coil 121 and/or off-board coil 111 has been moved out of position. Correction of such misalignments or airgap may require the user to reposition the EV 140, which may result in delays and/or poor user experience.

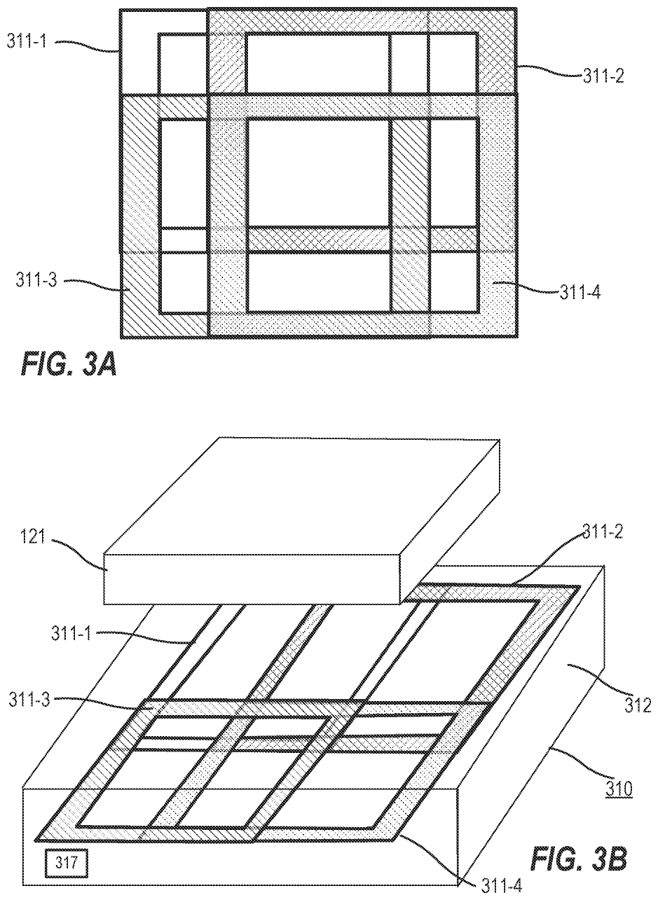

To address these and other issues, some embodiments of the present inventive concepts provide methods, systems, and devices which may be able to detect and/or minimize misalignment or airgap issues that would reduce or prevent effective coupling between the on-board and off-board coils. FIG. 3A and 3B illustrate a charging apparatus 310 that may be used in the off-board inductive charging system 110 of FIGS. 1A-C instead of, or in addition to, the off-board coil 110/110F. FIG. 3A is a top view of some components of the charging apparatus 310, and FIG. 3B is a perspective view showing some components of the charging apparatus 310. Those skilled in the art will readily appreciate that not all components of the charging apparatus are shown and described in the interest of brevity.

The charging apparatus 310 comprises a housing 312 with a plurality of emitter coils 311-1 to 311-4 therein. Herein, when the charging apparatuses according to embodiments of the present disclosure include multiple of the same components, these components may be referred to individually by their full reference numerals (e.g., a first coil 311-1) and may be referred to collectively by the first part of their reference numeral (e.g., the coils 311). Additionally, while four coils 311-1 to 311-4 are shown in FIGS. 3A and 3B, the present disclosure is not limited thereto. For example, two, three, or more than four coils 311 may be present in the charging apparatus 300.

In some embodiments, the housing 312 may have a substantially planar base or bottom surface that is parallel to a floor or ground surface of the parking location where the housing 312 is installed. The housing 312 may also have one or more substantially planar side surfaces and/or one or more substantially planar upper surfaces, some of which may be angled with to the base. In some embodiments, the plurality of coils 311 may be installed to be coplanar with one of the side surfaces or upper surfaces of the housing 312. In some embodiments, the plurality of coils 311 may be installed within the housing 312 at a depth from one of the side surfaces or upper surfaces. Each of the plurality of coils 311 may be a uniform depth from the side surface or upper surface of the housing 312. In some embodiments, the housing 312 may be or may resemble a parking bumper. In some embodiments, a center or central portion of each of the plurality of emitter coils 311 may be offset in the first (X) and second (Y) axes from a center or central portion of the housing 312 when viewed in a plan view or when a plane in which the plurality of coils 311 are positioned is viewed in a plan view.

The charging apparatus may also include a microcontroller 317 that is coupled to each of the plurality of coils 311. The microcontroller 317 may be within or on the housing 312 or may be separate therefrom and coupled via wires. In operation, the microcontroller 317 may be configured to cause AC that is provided from an energy source (not shown) to pass through one or more of the coils 311 present in the charging apparatus 310. As described above, this AC creates a fluctuating magnetic field as it moves through the coil, which in turn induces a current in the on-board coil 121 present in the EV 140, which can be used to charge an on-board battery of the EV 140.

Additionally, the microcontroller 317 may be configured to identify one or more of the coils 311 present in the charging apparatus 310 to activate. In some embodiments, the microcontroller 317 may identify a coil 311 from among the plurality of coils 311 that has the highest or greatest energy transfer efficiency. For example, each of the plurality of coils 311 may be activated one-by-one in a sequence, and feedback indicative of the amount of energy being transferred for each coil (such as a coupling factor) may be received by the microcontroller 317. As examples, the feedback may be received from the coils 311 and/or from a device on the EV 140 such as the on-board coil 121.

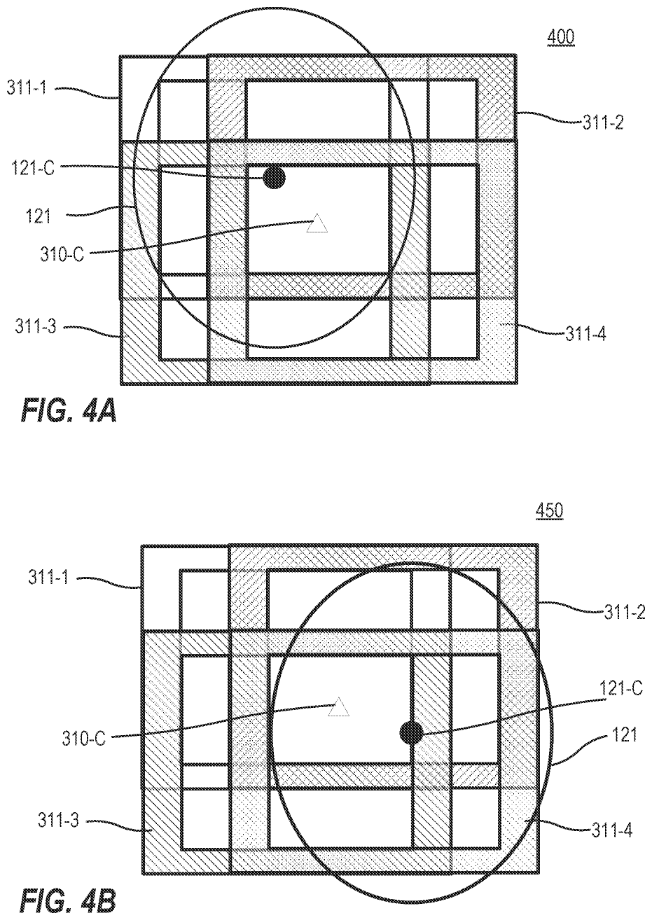

The charging apparatus 310 and the plurality of coils 311 thereof may minimize misalignment and/or airgap issues. FIGS. 4A and 4B illustrate examples of how the charging apparatus 310 and the plurality of coils 311 thereof may be used to transfer energy to an on-board coil 121 of an EV 140 despite a horizontal misalignment between the EV 140 relative to the housing 312.

In example 400 of FIG. 4A, the center 121-C of the on-board coil 121 is offset up and to the left (when viewed in a plan view, or from the perspective of the EV 140) relative to the center 310-C of the charging apparatus 310. In example 450 of FIG. 4B, the center 121-C of the on-board coil 121 is offset down and to the right (again when viewed in a plan view, or from the perspective of the EV 140) relative to the center 310-C of the charging apparatus 310. Despite these misalignments, the microcontroller 317 may be able to initiate transfer of energy from the charging apparatus 310 to the on-board coil 121 by selecting the first coil 311-1 in example 400 of FIG. 4A, and by selecting the fourth coil 311-4 in the example 450 of FIG. 4B.

In some embodiments, the plurality of coils 311 may be arranged to provide for energy transfer despite a misalignment that may be measured as a percentage of a width (in the first or X-axis) or depth (in the second or Y-axis) of the housing 312 or of a component of the EV 140. For example, energy transfer may be initiated if a center 121-C of the on-board coil 121 is offset from a center 310-C of the charging apparatus 310 by 10-40% of the width of the housing 312 or component of the EV 140 in the first axis. As another example, energy transfer may be initiated if a center 121-C of the on-board coil 121 is offset from a center 310-C of the charging apparatus 310 and 20-80% of the depth of the housing 312 or component of the EV 140 in the second axis.

In some embodiments, the power transferred may reach or exceed 20 kilowatts (KW). In some embodiments, the efficiency of the power transferred between the selected and activated off-board coil 311 and the on-board coil 121 may reach or exceed 95%.

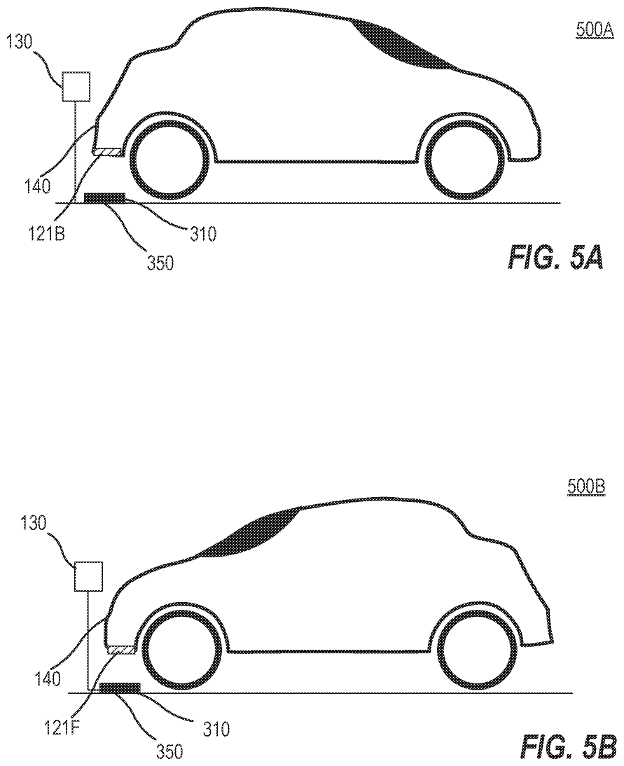

FIGS. 5A and 5B illustrate EV charging systems 500A and 500B, which are similar to the EV charging systems 100B and 100C of FIGS. 1B and 1C, respectively. FIGS. 5A and 5B demonstrate that in some embodiments, a positioning device 350 may be added to the charging apparatus 310. The positioning device 350 and/or the microcontroller 317 may be configured to check or determine the presence of the parked EV 140, which may be used to trigger the identification of one of the plurality of coils 311 to activate and use for energy transfer. For example, the positioning device 350 may be an optical device configured to detect the presence of the EV 140 optically or a RF-based device configured to receive an RF signal from the EV 140. FIG. 5A also illustrates that an on-board coil 121F may be located at a front portion or front bumper of the EV 140, and FIG. 5B also illustrates that the on-board coil 121B may be located at a rear portion or rear bumper of the EV 140. The charging apparatus 310 may be located at a front portion of the parking location. A controller 130 may be communicatively coupled to the charging apparatus 310 and may be used by a user to initiate charging of the EV 140 (i.e., initiate a transfer of energy through inductive coupling of the off-board coil 111 and the on-board coil 121) and perform other actions with respect to the EV charging systems 500A and 500B.

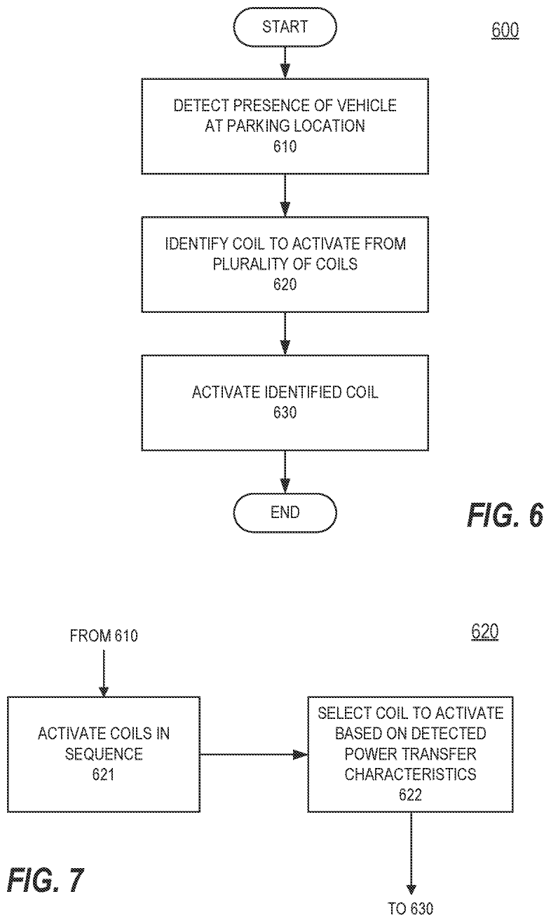

FIG. 6 is a flowchart illustrating operations within methods of initiating energy transfer from a charging apparatus 300 comprising a plurality of coils 311 to a on-board coil of an electric vehicle 140 according to aspects of the present disclosure. Accordingly, FIG. 6 may be understood to be a flowchart illustrating operations within methods of charging an electric vehicle according to aspects of the present disclosure. FIG. 7 is a flowchart illustrating and providing greater detail of an operation shown in FIG. 6.

In FIG. 6 and flowchart 600 thereof, in operation 610 a charging apparatus, and specifically a controller or microcontroller thereof, may detect a presence of a vehicle at a parked location associated with the charging apparatus. For example, the charging apparatus 310 (and the positioning device 350 thereof) may be configured to detect the presence the EV 140 and the on-board coil 121 thereof. In some embodiments, the EV 140 may be configured to transmit a signal to the positioning device 350 when the EV 140 is in a general position within the parking location. In some embodiments, on-board inductive charging system 120 may be configured to transmit an acknowledgement responding to an identification pulse or signal transmitted by the positioning device 350.

In operation 620, the charging apparatus may be configured to identify a coil to activate from the plurality of coils 311. As seen in FIG. 7, in some embodiments, identifying a coil to activate from the plurality of coils 311 may comprise activating each of the coils 311 in a sequence in operation 621, and then selecting a coil from among the plurality of coils 311 to activate based on detected power transfer characteristics. These detected power transfer characteristics may be detected by the coils 311 and/or based on signals from a device on the EV 140 such as the on-board coil 121.

Returning to FIG. 6, in operation 630 the identified coil from the plurality of coils may be activated.

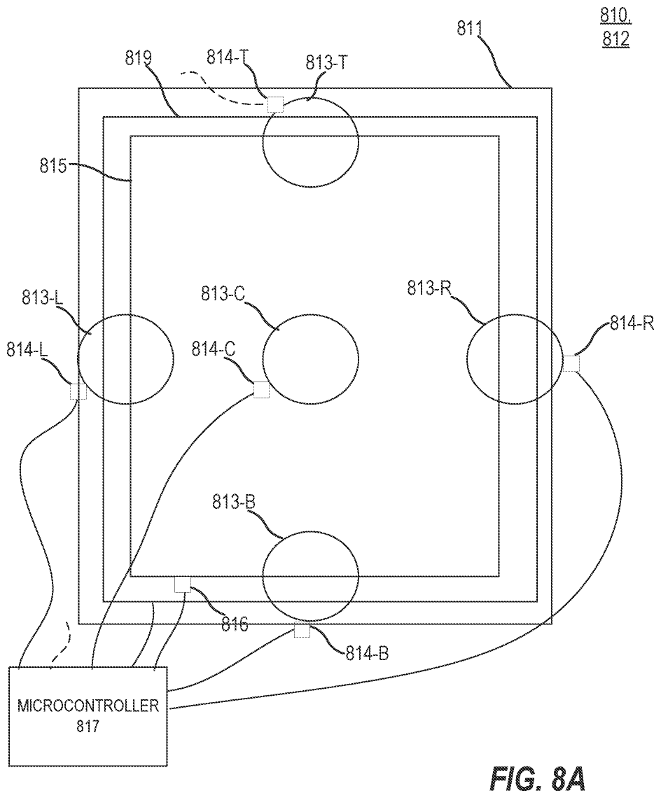

The EV charging systems described above with reference to FIGS. 3-7 may be able to reduce the frequency of misalignments in which power cannot be transferred from the off-board system to the on-board system, and/or the frequency of misalignments in which power is transferred inefficiently. Example embodiments of the present inventive concepts will now be described with reference to FIGS. 8A-12 and 15 in which a off-board system may detect a presence and position of an on-board system of an EV positioned in the proximity of the off-board charging system, and vice versa, and if the positioning of the off-board and on-board systems is able to support a proper and safe power transfer. Misalignments and/or airgaps in which power cannot be transferred from the off-board system to the on-board system, and/or misalignments or airgaps in which power would be transferred inefficiently can thus be identified. Example embodiments of the present inventive concepts described with reference to FIGS. 8A-12 and 15 in which data may be transmitted from the vehicle to the charger from a short-range wireless communication system before, during, and after a charging system.

FIG. 8A shows a charging apparatus 810 of an off-board system in accordance with aspects of the present disclosure. The charging apparatus 810 may include a housing 812 having therein a power transfer coil 811, a plurality of horizontal alignment coils 813, horizontal alignment signal processing circuits 814, a data reception and airgap alignment coil 815, a data reception and airgap alignment signal processing circuit 816, a signal emission coil 819, and a microcontroller 817. The charging apparatus 810 may be a component within an off-board inductive charging system (with power transfer coil 811 analogous to the off-board coils 111 and 311 discussed above) and may be used in EV charging systems having components similar to those of FIGS. 1A-C and FIGS. 5A-B. The similar components and systems are not described again herein in the interest of brevity.

In some embodiments, the housing 812 may have a substantially planar base or bottom surface that is parallel to a floor or ground surface of the parking location where the housing 812 is installed. The housing 812 may also have one or more substantially planar side surfaces and/or one or more substantially planar upper surfaces, some of which may be angled with to the base. In some embodiments, the power transfer coil 811, signal emission coil 819, horizontal alignment coils 813, and data reception and airgap alignment coil 815 may be installed to be coplanar with one of the side surfaces or upper surfaces of the housing 812. In some embodiments, the power transfer coil 811, horizontal alignment coils 813, data reception and airgap alignment coil 815, and signal emission coil 819 may be installed within the housing 812 at a depth from one of the side surfaces or upper surfaces. Each of the power transfer coil 811, horizontal alignment coils 813, and data reception and airgap alignment coil 815 may be a uniform depth from the side surface or upper surface of the housing 812. In some embodiments, the housing 812 may be or may resemble a parking bumper.

The power transfer coil 811 may be similar to the emitter coils 111 and 311 discussed above. In operation, the microcontroller 817 may be configured to cause AC that is provided from an energy source (not shown) to pass through the power transfer coil 811 present in the charging apparatus 800. As described above, this AC creates a fluctuating magnetic field as it moves through the coil, which in turn induces a current in an on-board coil 121 present in the EV 140, which can be used to charge an on-board battery of the EV 140.

Each of the plurality of horizontal alignment coils 813 may be configured to receive an alignment signal during an alignment phase of a charging operation in which energy is to be transferred from the charging apparatus 810 to the EV 140. The alignment phase of the charging operation may be performed prior to the initiation of an energy transfer and may serve as a decision point for the charging apparatus 810 to decide whether the energy transfer may be initiated safely and efficiently. As seen in FIG. 8A, five horizontal alignment coils 813 may be present in the charging apparatus 810, although the present disclosure is not limited thereto. In the embodiment illustrated in FIG. 8A, the plurality of horizontal alignment coils 813 may include a top alignment coil 813-T, a left alignment coil 813-L, a right alignment coil 813-R, a bottom alignment coil 813-B, and a center alignment coil 813-C.

Each of the plurality of horizontal alignment coils 813 may be coupled to the microcontroller 817 via a respective one of the plurality of horizontal alignment signal processing circuits 814. Although FIG. 8A shows each horizontal alignment signal processing circuit 814 as closer to its respective one of the plurality of horizontal alignment coils 813 than to the microcontroller 817, the present disclosure is not limited thereto.

An example of a horizontal alignment signal processing circuit 814 is shown in the block diagram of FIG. 10. Each horizontal alignment signal processing circuit 814 may include a resonant tank circuit 814-1 associated with a tuned capacitor. The resonant tank circuit 814-1 may be configured to maximize an amplitude of a received signal at the emitter frequency and minimize the amplitude for all other signals. This may improve a signal quality of the emitter and protect the positioning circuit from the strong electromagnetic field of the primary converter. Each horizontal alignment signal processing circuit 814 may also include an envelope filter 814-2 which may be configured to provide a DC signal readable by the microcontroller 817. The DC signal may be based on a shape of a waveform of the AC signal received by the respective alignment coil 813.

The data reception and airgap alignment coil 815 may also be configured to receive the alignment signal during the alignment phase of the charging operation. The data reception and airgap alignment coil 815 may be coupled to the microcontroller 817 via the data reception and airgap alignment signal processing circuit 816. Although FIG. 8A shows the data reception and airgap alignment signal processing circuit 816 as closer to the data reception and airgap alignment coil 815 than to the microcontroller 817, the present disclosure is not limited thereto. An example of data reception and airgap alignment signal processing circuit 816 will be described with reference to FIG. 11.

The signal emission coil 819 may also be configured to transmit an alignment signal during the alignment phase of the charging operation and/or a data signal in phases of the charging operation other than the alignment phase. The signal emission coil 819 may be coupled to the microcontroller 817 via a signal emission signal processing circuit (not shown).

The microcontroller 817 may be configured to detect horizontal alignments and/or misalignments and vertical spacing or airgap between the on-board coil 121 and the power transfer coil 811. Horizontal alignments and/or misalignments may be detected based on performed comparisons of magnitudes of signals received from each of the left alignment coil 813-L, top alignment coil 813-T, bottom alignment coil 813-B, and right alignment coil 813-R with the magnitude of the signal received from the center alignment coil 813-C. The magnitude of each coil signal 813 may be a voltage of the DC signal output by the corresponding and respective horizontal alignment signal processing circuit 814. If the magnitude of the signals received from the left alignment coil 813-L or right alignment coil 813-R exceeds the magnitude of the signal received from the center alignment coil 813-C, then the microcontroller 817 may determine or decide that the on-board coil 121 is misaligned in the first (X) axis. If the magnitude of the signals received from the top alignment coil 813-T or bottom alignment coil 813-B exceeds the magnitude of the signal received from the center alignment coil 813-C, then the microcontroller 817 may determine or decide that the on-board coil 121 is misaligned in the second (Y) axis.

Airgaps may be detected based on performed comparisons of magnitudes of signals received from the data reception and airgap alignment coil 815 with a threshold value. If the magnitude of the signal received from the data reception and airgap alignment coil 815 exceeds the threshold value, then the microcontroller 817 may determine or decide that the on-board coil 121 is sufficiently close in the third (Z) axis. If the magnitude of the signal received from the data reception and airgap alignment coil 815 does not exceed the threshold value, then the microcontroller 817 may determine or decide that there is an airgap between the on-board coil 121 and the off-board coil 111.

The microcontroller 817 may be configured to determine or decide that the on-board coil 121 is aligned with the power transfer coil 811 in one horizontal axis and misaligned in the other horizontal axis, misaligned in both horizontal axes, or aligned in both horizontal axes, and may perform an action responsive to the determination or decision. The microcontroller 817 may be configured to determine or decide that the on-board coil 121 is misaligned with the power transfer coil 811 in the vertical axis or aligned in the vertical axis, and may perform an action responsive to the determination or decision.

As seen in FIG. 8B, the EV 140 (e.g., an on-board system) may also include a charging apparatus 860 may include a power reception coil 821, a plurality of horizontal alignment coils 863, horizontal alignment signal processing circuits 864, a data reception and airgap alignment coil 865, a data reception and airgap alignment signal processing circuit 866, a signal emission coil 869, and a microcontroller 867. The power reception coil 821 may be similar to the on-board coil 121 discussed above, and may be on the underside or ground-facing side of the EV 140. The power reception coil 821 may be positioned on the underside or ground-facing side of the EV 140 between the front and rear wheels of the EV 140, and/or at a central portion of the EV 140.

The remaining components of the charging apparatus 860 may be similar to the corresponding components of the charging apparatus 810. In other words, the plurality of horizontal alignment coils 863 may be similar to the horizontal alignment signal processing circuits 864, data reception and airgap alignment coil 865, data reception and airgap alignment signal processing circuit 866, signal emission coil 869, and the microcontroller 867 of the charging apparatus 860 may each be similar to the corresponding plurality of horizontal alignment coils 813, horizontal alignment signal processing circuits 814, data reception and airgap alignment coil 815, data reception and airgap alignment signal processing circuit 816, signal emission coil 819, and microcontroller 867 of the charging apparatus 810, and duplicate description thereof is omitted herein in the interest of brevity. In some embodiments, the components of the charging apparatus 860 may be within a housing mountable onto the EV 140.

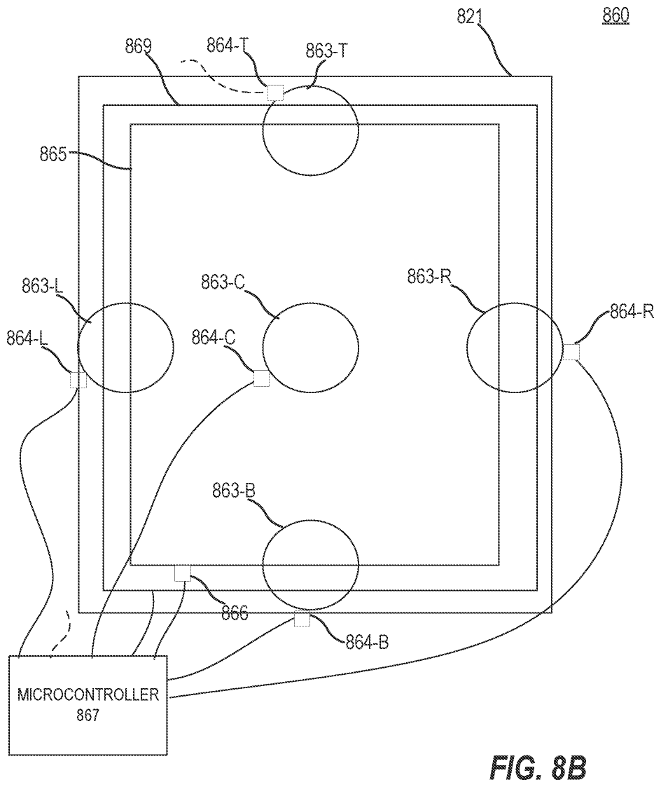

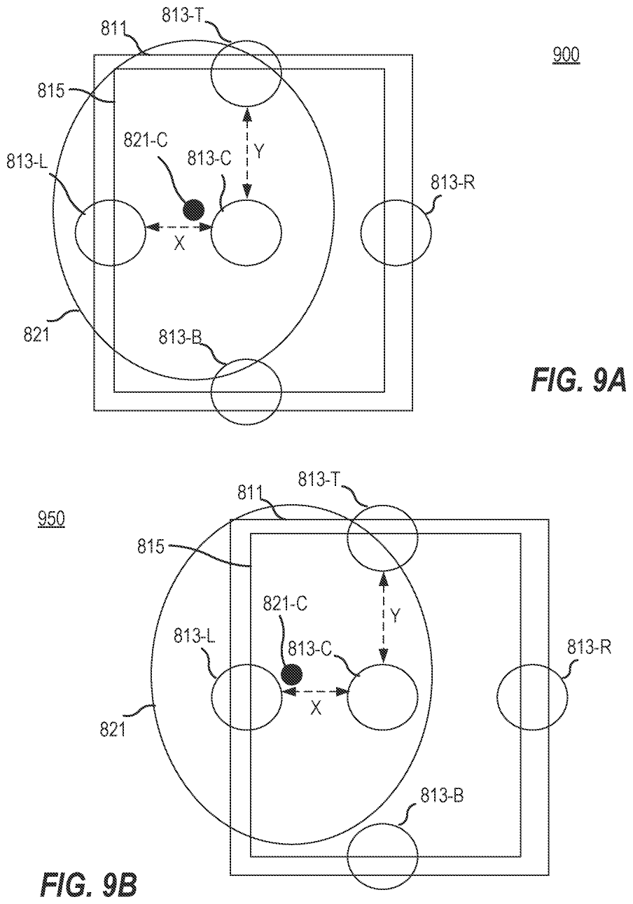

The charging apparatuses 810/860 and the plurality of alignment coils 813/863 and 815/865 thereof may be used to detect an alignment of the EV 140 and the power reception coil 821 relative to the power transfer coil 811. FIGS. 9A and 9B illustrate examples of how the charging apparatus 810 and the plurality of coils 813 thereof may be used to detect a horizontal alignment of the EV 140 relative to the housing 812.

In example 900 of FIG. 9A, the center 821-C of the on-board power reception coil 821 is offset a first distance to the left (when viewed in a plan view, or from the perspective of the EV 140) of the center of the center coil 812-C of the plurality of coils 811 of the charging apparatus 810. In example 950 of FIG. 9B, the center 821-C of the on-board power reception coil 821 is offset a second distance to the left (when viewed in a plan view, or from the perspective of the EV 140) of the center of the center coil 812-C of the plurality of coils 811 of the charging apparatus 810. In each of the examples 900 and 950, the microcontroller 817 may receive a left signal from the left coil 813-L and a center signal from the center coil 813-C, and may compare a magnitude of the left signal with a magnitude of the center signal. The magnitude of the left signal may be a voltage of the DC signal output by the left horizontal alignment signal processing circuit 814-L, and the magnitude of the center signal may be a voltage of the DC signal output by the center horizontal alignment signal processing circuit 814-C. In example 900 of FIG. 9A, the magnitude of the center signal may exceed the magnitude of the left signal, and accordingly the microcontroller 817 may determine or decide that the on-board power reception coil 821 is not misaligned to the left. In example 950 of FIG. 9B, the magnitude of the center signal may be less than the magnitude of the left signal, and accordingly the microcontroller 817 may determine or decide that the on-board power reception coil 821 is misaligned to the left.

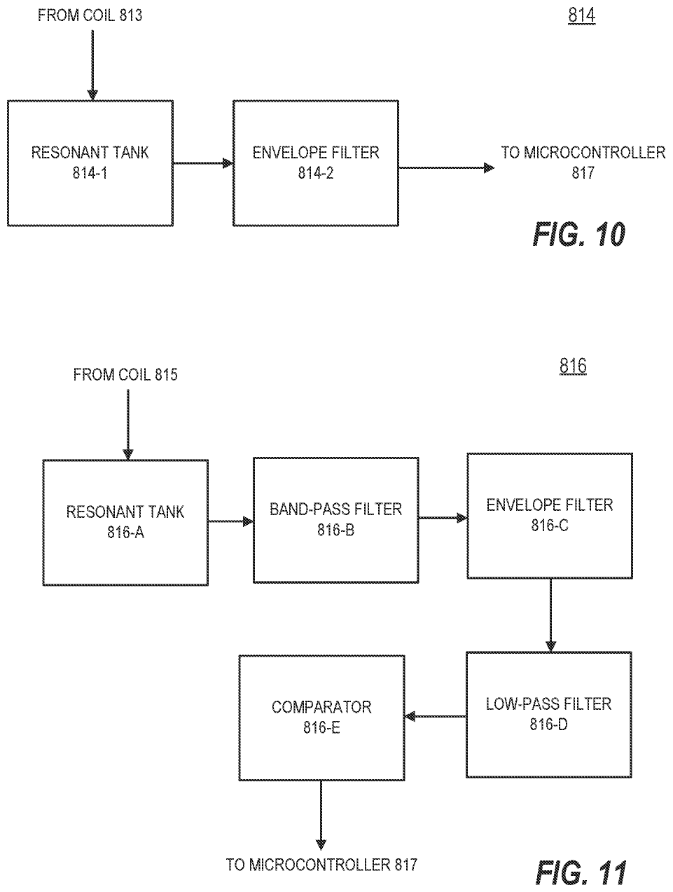

FIG. 12 is a flowchart illustrating operations within methods of initiating energy transfer from a charging apparatus 810 to an on-board coil 121/821 of an electric vehicle 140, where the charging apparatus 810 includes a power transfer coil 811, a plurality of horizontal alignment coils 813, and a vertical alignment coil 815, according to aspects of the present disclosure. Accordingly, FIG. 12 may be understood to be a flowchart illustrating operations within methods of charging an electric vehicle according to aspects of the present disclosure.

In FIG. 12 and flowchart 1200 thereof, in operation 1210 a charging apparatus, and specifically a controller or microcontroller thereof, may detect a presence of a vehicle at a parked location associated with the charging apparatus. For example, the charging apparatus 810 (and the signal emission coil 819 thereof) may periodically transmit an identification pulse or signal. In other words, the charging apparatus 810 may be periodically transmit an “Are you there?” signal. The on-board inductive charging system 120 of the EV 140 and the data reception coil 815 thereof may be configured to receive the identification pulse or signal when the EV 140 is in a general position within the parking location. The on-board inductive charging system 120 or charging apparatus 860 may be configured to transmit (via the signal emission coil 869) an acknowledgement responding to the identification pulse or signal. In other words, the on-board inductive charging system 120 or charging apparatus 860 may respond to the “Are you there?” signal with an “I'm here” signal.

Once a presence of an EV 140 has been detected, in operation 1220 the position of the EV may be analyzed using the plurality of horizontal alignment coils 813 and the airgap alignment coil 815 as described above. For example, the microcontroller 817 may detect horizontal alignments or misalignments based on performed comparisons of magnitudes of signals received from each of the left alignment coil 813-L, top alignment coil 813-T, bottom alignment coil 813-B, and right alignment coil 813-R with the magnitude of the signal received from the center alignment coil 813-C. The microcontroller 817 may detect vertical spacing and/or airgaps based on performed comparisons of magnitudes of signals received from the data reception and airgap alignment coil 815 with a threshold value.

In operation 1225, a determination is made as to whether the EV 140 is aligned. If the EV 140 is not aligned (“N” branch from operation 1225), then in operation 1240 one or more misaligned actions may be performed. For example, a message may be communicated to the EV 140 and/or to the user that the EV 140 is not aligned. On the other hand, if the EV 140 is aligned (“Y” branch from operation 1225), then in operation 1230 one or more aligned actions may be performed. For example, a message may be communicated to the EV 140 and/or to the user that the EV 140 is aligned, and/or a subsequent operation in methods of charging the EV 140 may be performed. In some embodiments, an aligned action performed in operation 1230 include activating the power transfer coil 811.

In some embodiments, operation 1210 of the flowchart 1200 of FIG. 12 may be performed as part of an identification phase of a method of charging the EV 140, operations 1220, 1225, and 1240 may be performed as part of an alignment phase and/or a standby phase of a method of charging the EV 140, and operation 1230 may be performed as part of a charge phase of a method of charging the EV 140.

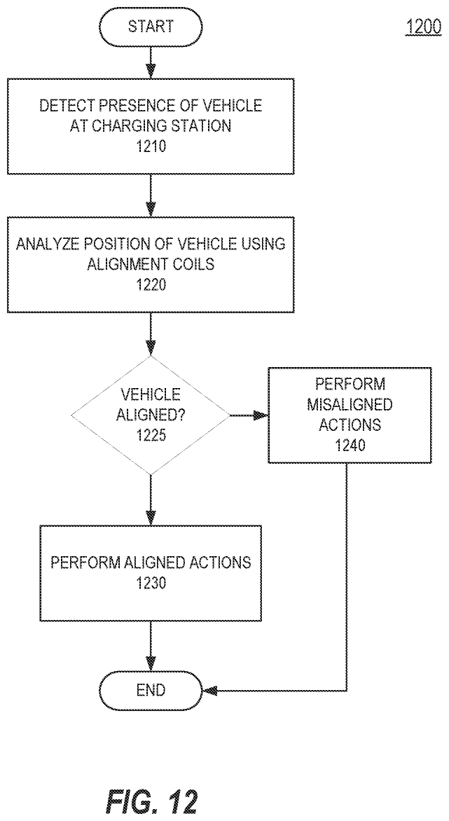

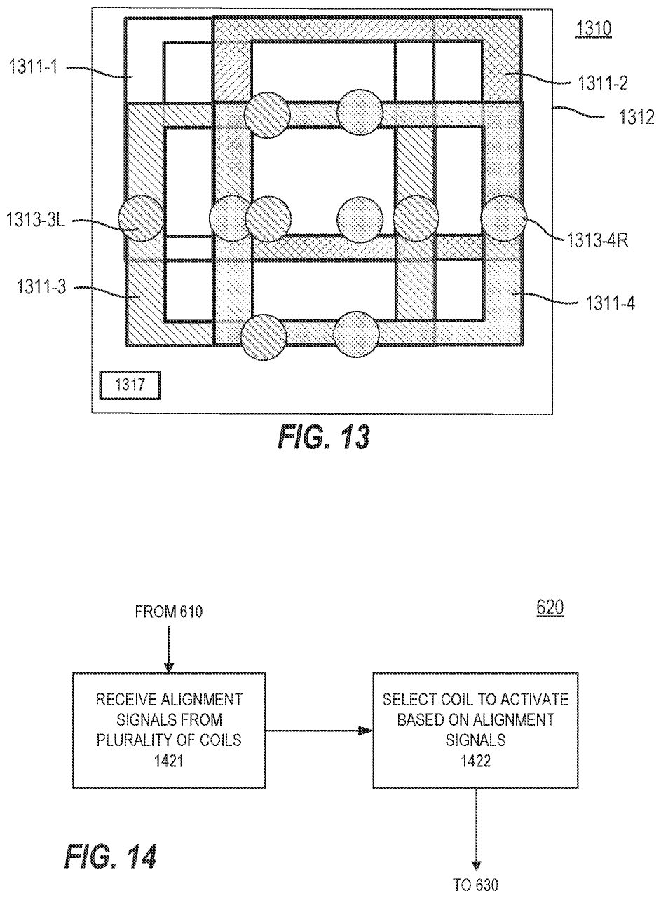

In some embodiments, the inventive concepts described above with reference to FIGS. 3-7 may be combined with the inventive concepts described above with reference to FIGS. 8A-12 and 15. Accordingly, some aspects of the present disclosure provide a charging apparatus that may detect a presence and position of an EV positioned in the proximity of the charging apparatus and that may be able to reduce the frequency of misalignments in which power cannot be transferred from the off-board system to the on-board system, and/or the frequency of misalignments in which power is transferred inefficiently. Example embodiments of the present inventive concepts will now be described with reference to FIGS. 13 and 14.

FIG. 13 illustrates a top view of some components of a charging apparatus 1310 that may be used in an off-board inductive charging system, such as those already described herein. Those skilled in the art will readily appreciate that not all components of the charging apparatus are shown and described in the interest of brevity.

The charging apparatus 1310 may include comprises a housing 1312 with a plurality of primary power transfer coils 1311-1 to 1311-4 therein. While four primary power transfer coils 1311-1 to 1311-4 are shown in FIG. 13, the present disclosure is not limited thereto. The housing 1312 may be similar to the housings 312 and 812 already described.

Each of the plurality of primary power transfer coils 1311 may have a respective plurality of horizontal alignment coils 1313 which may be provided in a similar number and arrangement as seen in FIG. 8A. As an example, where four primary power transfer coils are 1311-1 to 1311-4 are present in the charging apparatus 1310, there may be twenty horizontal alignment coils 1313 (four sets of horizontal alignment coils 1313 corresponding respectively to the four primary power transfer coils 1311, with five alignment coils 1313 in each set). Only the horizontal alignment coils 1313 that correspond to the primary power transfer coils 1311-3 and 1311-4 are shown in FIG. 13 to improve the clarity of the illustration. As discussed above, each horizontal alignment coil 1313 may be configured to receive an alignment signal from the EV 140 during an alignment phase of a charging operation in which energy is to be transferred from the charging apparatus 1310 to the EV 140.

The microcontroller 1317 may be configured to detect horizontal alignments and/or misalignments, and/or vertical spacing and/or airgaps between the on-board coil 121 relative to each primary power transfer coil 1311. For example, horizontal alignments and/or misalignments may be detected based on performed comparisons of magnitudes of signals received from each of the left coil, top coil, bottom coil, and right coil with the magnitude of the signal received from the center coil of each set of horizontal alignment coils 1313.

Additionally, the microcontroller 1317 may be configured to identify one or more of the power transfer coils 1311 present in the charging apparatus 1310 to activate. In some embodiments, the microcontroller 1317 may identify a power transfer coil 1311 from among the plurality of power transfer coils 1311 that has the highest or greatest energy transfer efficiency. For example, the microcontroller 1317 may identify a power transfer coil 1311 from among the plurality of power transfer coils 1311 that is aligned or is most aligned with the on-board coil 121, based on the detected horizontal alignments and/or misalignment.

Additionally, the microcontroller 1317 may be configured to detect vertical spacing and/or airgaps based on performed comparisons of magnitudes of a signal received from a data reception and airgap alignment coil (not shown in FIG. 13) with a threshold value.

FIG. 14 in conjunction with FIG. 6 is a flowchart according to aspects of the present disclosure. The flowchart of FIGS. 6 and 14 illustrates operations within methods of initiating energy transfer to an on-board coil of an electric vehicle 140 from a charging apparatus 1310 comprising a plurality of power transfer coils 1311 each associated with a respective plurality of horizontal alignment coils 1313. Accordingly, FIGS. 6 and 14 may be understood to be a flowchart illustrating operations within methods of charging an electric vehicle according to aspects of the present disclosure.

As previously discussed, in operation 620 of FIG. 6, the charging apparatus may be configured to identify a coil to activate from the plurality of power transfer coils 1311. As seen in FIG. 14, in some embodiments, identifying a coil to activate from the plurality of power transfer coils 1311 may comprise receiving alignment signals from each plurality of horizontal alignment coils 1313 associated with a respective one of the power transfer coils 1311 in operation 1421, and then selecting a coil from among the plurality of power transfer coils 1311 to activate based on the received alignment coils in operation 1422. For example, the microcontroller 1317 may select a power transfer coil 1311 from among the plurality of power transfer coils 1311 that is aligned or is most aligned with the on-board power reception coil 121/821, based on the received alignment signals.

In addition to detection and reduction of misalignments as discussed above, aspects of the present disclosure are based on the recognition that it may be desirable to communicate messages (including commands, requests, instructions, information, acknowledgements, or the like) between components of the off-board system and components of the on-board system. In some embodiments, this information may be communicated via a pathway independent of the off-board and on-board coils, such as via a separate optical or RF connection. Referring again to FIGS. 8A and 8B, the signal emission coils 819/869 and the data reception and airgap alignment coil 815/865 may be used to facilitate communication in a bidirectional fashion between the charging apparatuses 810 and 860 (and thus, between a charging system and an EV 140).

It may be desirable that bi-directional communication may occur before, during, and after energy is transferred using the off-board and on-board coils. For example, some messages that may be communicated prior to initiation of energy transfer may include an identity of the EV 140 or a user thereof, payment or account information, compatibility information, information about energy to be transferred, and/or alignment information (e.g., the EV 140 is aligned or is not aligned). Some messages that may be communicated during energy transfer (e.g., while the power transfer coil 811 is activated) includes information about energy being transferred, communications regarding the charging process, regulation data or “heartbeat” indicating the presence of the EV 140 and so on. Some messages that may be communicated after energy transfer may include confirmations of an amount of energy transferred, payment or account information, and so on.

To facilitate communication, the charging apparatuses 810/860 may be configured to use signal emission coils 819/869 for data transmission, and the data reception and airgap alignment coil 815/865 for data reception. The data reception and airgap alignment coils 815/865 may be coupled to a data reception and airgap alignment signal processing circuit 816/866.

Messages may be transferred from the charging apparatus 810 to charging apparatus 860, and vice versa, by emitting signals using signal emission coils 819/869 and receiving signals using the data reception and airgap alignment coils 815/865. Various communication schemes may be employed to coordinate communication between the charging apparatus 810 and the charging apparatus 860. For example, communications may be time-division multiplexed, such that the charging apparatus 810 transmits communications during a first time slot and the charging apparatus 860 transmits communications during a second time slot. As another example, communications may be frequency-division multiplexed, such that the charging apparatus 810 transmits using a first frequency or frequency band, and the charging apparatus 860 transmits communications in a second frequency or frequency band.

For example, the microcontroller 817 may be configured to cause a communication signal to be applied to the signal emission coil 819. The microcontroller 817 may be configured to receive signals from the data reception and airgap alignment coil 815 and extract messages or data therefrom.

During energy transfer, the data reception and airgap alignment coil 815 may receive both an AC communication signal emitted from the signal emission coil 869 of the EV 140 (i.e., a signal including a message from the EV 140) as well as the AC power signal emitted from the power transfer coil 811 of the charging apparatus 810. This AC power signal may dominate the communication signal. Accordingly, the data reception and airgap alignment signal processing circuit 816 may be provided to separate the communication signal from the AC power signal.

An example of the data reception and airgap alignment signal processing circuit 816 is shown in the block diagram of FIG. 11. The data reception and airgap alignment signal processing circuit 816 may include a resonant tank circuit 816-A, a band-pass filter 816-B, an envelope filter 816-C, a low-pass filter 816-D, and a comparator 816-E. The resonant tank circuit 816-A may be similar to the resonant tank circuit 814-A discussed with reference to the horizontal alignment signal processing circuit 814 and may be configured to maximize an amplitude of a received signal at the communication frequency band and minimize the amplitude for all other signals. An output of the resonant tank circuit 816-A may be provided to the band-pass filter 816-B, which may be configured to block a low frequency part of the received signal. For example, the band-pass filter may be configured to block signals in a frequency band associated with the AC power signal emitted from the power transfer coil 811, and pass signals in a different frequency band associated with communications between the charging apparatus 810 and the charging apparatus 860. The data reception and airgap alignment signal processing circuit 816 may also include an envelope filter 816-C and low pass filter 816-D which may be configured to filter noise and other signal components from the received signal. The cleaned-up signal may be provided to a comparator 816-E, which may be configured to digitize the signal for the microcontroller 817.

Although the above discussion of how components of the charging apparatus 860 and the charging apparatus 810 may communicate bidirectionally is provided with reference to FIGS. 8A and 8B, it is to be understood that the inventive concepts thereof may be applied to the charging apparatus 310 or 1310. In other words, exemplary embodiments of the present disclosure may include one or more of the plurality of emitter coils 311, the plurality of horizontal alignment coils 813, and/or the data reception and alignment coil 815.

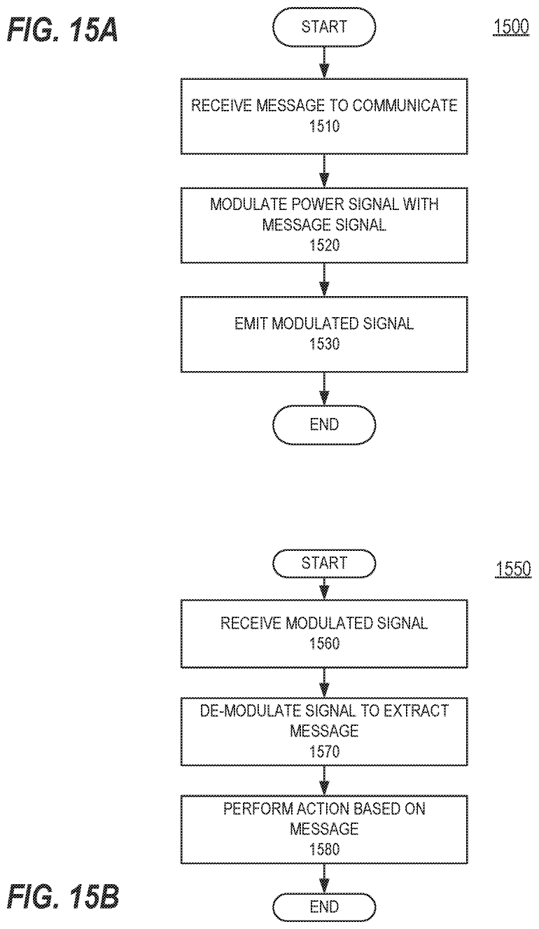

FIGS. 15A and 15B are flowcharts which illustrate communication of a message between an on-board component of the EV (e.g., the EV 140 of FIGS. 1A-C and 5A-B) and other components of an EV charging system (e.g., the EV charging systems 100A, 100B, 100C, 500A, and 500B of FIGS. 1A-C and 5A-B) during a transfer of energy, according to some embodiments of the present inventive concepts. The communication may be between an on-board component of the EV (e.g., charging apparatus 860) and the other components of the EV charging system may occur an “uplink” direction from an on-board coil (e.g., signal emission coil 869 of FIG. 8B) to an off-board coil (e.g., the data reception and airgap measurement coil 815 of FIG. 8A), or in a “downlink” direction from an off-board coil (e.g., the signal emission coil 819 of FIG. 8A) to an on-board coil (e.g., the data reception and airgap measurement coil 865 in FIG. 8B).

FIG. 15A and FIG. 15B describe transmitting/emitting a message and receiving a message, respectively. FIGS. 15A and 15B are described from the perspective of an off-board inductive charging system or apparatus (e.g., the charging apparatuses 310, 810, and 1310 of the present disclosure) with the understanding that those skilled in the art will readily appreciate that the on-board system (e.g., the charging apparatus 860) may also emit and receive messages accordingly. Different messages (i.e., first and second messages) are discussed with respect to FIGS. 15A and 15B.

In FIG. 15A and flowchart 1500 thereof, in operation 1510 a charging apparatus, and specifically a controller or microcontroller thereof, may receive a message to communicate via a signal emission coil (e.g., signal emission coil 819). The message may be converted into a message signal. In operation 1520, a power signal supplied to the signal emission coil 819, which as described above is an AC signal having a frequency, may be modulated using the message signal. The modulated signal may be emitted in operation 1530.

To illustrate by example, a message to be communicated may comprise a binary sequence having 0s and 1s. When a binary ‘0’ is to be communicated, the power signal may not be modulated, or may be modulated with a first frequency. When a binary ‘1’ is to be communicated, the power signal may be modulated, or may be modulated with a second frequency different from the first frequency. For example, if the power signal is a 100 kilohertz (kHz) signal, then transmission of a binary ‘0’ in the message may comprise emitting the 100 kHz signal, and transmission of a binary ‘1’ may comprise emitting the 100 kHz signal modulated with a 10-megahertz (mHz) signal.

In FIG. 15B and flowchart 1550 thereof, in operation 1560 a charging apparatus may receive a modulated signal via a reception coil (e.g., data reception and airgap alignment coil 815). In operation 1570, the modulated signal may be de-modulated using a signal processing circuit, such as the data reception and airgap alignment signal processing circuit 816, and a message may be extracted therefrom. The signal processing circuit may comprise a band-pass filter to separate out a lower frequency signal from the modulated signal, resulting in a communication signal comprising the message. In operation 1580, one or more actions may be performed based on the extracted message.

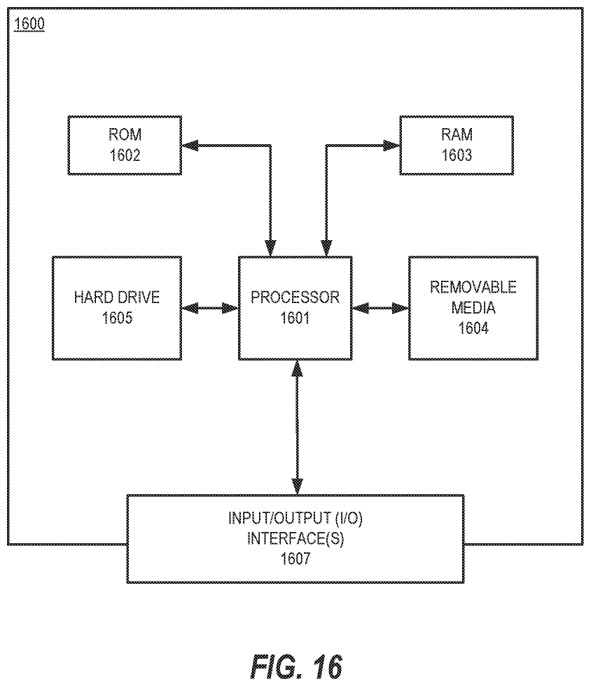

FIG. 16 illustrates various components of a computing device 1600 which may be used to implement one or more of the devices herein, including the controller 130 of FIGS. 1A-C and 4A-B, the computing device associated with the EV 140 discussed in relation to FIGS. 1A-C and 4A-B, a computing device of the EV 140 itself, the microcontroller 616 of FIG. 7, and other computing devices that implement or embody the present inventive concepts. FIG. 16 illustrates hardware elements that can be used in implementing any of the various computing devices discussed herein. In some aspects, general hardware elements may be used to implement the various devices discussed herein, and those general hardware elements may be specially programmed with instructions that execute the algorithms discussed herein. In special aspects, hardware of a special and non-general design may be employed (e.g., ASIC or the like). Various algorithms and components provided herein may be implemented in hardware, software, firmware, or a combination of the same.

A computing device 1600 may include one or more processors 1601, which may execute instructions of a computer program to perform any of the features described herein. The instructions may be stored in any type of computer-readable medium or memory, to configure the operation of the processor 1601. For example, instructions may be stored in a read-only memory (ROM) 1602, random access memory (RAM) 1603, removable media 1604, such as a Universal Serial Bus (USB) drive, compact disk (CD) or digital versatile disk (DVD), floppy disk drive, or any other desired electronic storage medium. Instructions may also be stored in an attached (or internal) hard drive 1605. The computing device 1600 may be configured to provide output to one or more output devices (not shown) such as printers, monitors, display devices, and so on, and receive inputs, including user inputs, via input devices (not shown), such as a remote control, keyboard, mouse, touch screen, microphone, or the like. The computing device 1600 may also include input/output interfaces 1607 which may include circuits and/or devices configured to enable the computing device 1600 to communicate with external input and/or output devices (such as computing devices on a network) on a unidirectional or bidirectional basis. The components illustrated in FIG. 16 (e.g., processor 1601, ROM storage 1602) may be implemented using basic computing devices and components, and the same or similar basic components may be used to implement any of the other computing devices and components described herein. For example, the various components herein may be implemented using computing devices having components such as a processor executing computer-executable instructions stored on a computer-readable medium, as illustrated in FIG. 16. Some components of the computing device 1600 may be omitted in some implementations.

The inventive concepts provided by the present disclosure have been described above with reference to the accompanying drawings and examples, in which examples of embodiments of the inventive concepts are shown. The inventive concepts provided herein may be embodied in many different forms than those explicitly disclosed herein, and the present disclosure should not be construed as limited to the embodiments set forth herein. Rather, the examples of embodiments disclosed herein are provided so that this disclosure will be thorough and complete, and will fully convey the scope of the inventive concepts to those skilled in the art. Like numbers refer to like elements throughout.

Some of the inventive concepts are described herein with reference to block diagrams and/or flowchart illustrations of methods, apparatus (systems) and/or computer program products, according to embodiments of the inventive concepts. It is understood that one or more blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the inventive concepts may be embodied in hardware and/or in software (including firmware, resident software, micro-code, etc.). Furthermore, embodiments of the present inventive concepts may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory such as an SD card), an optical fiber, and a portable compact disc read-only memory (CD-ROM).

Well-known functions or constructions may not be described in detail for brevity and/or clarity.

The terms first, second, etc. may be used herein to describe various elements, but these elements should not be limited by these terms. These terms are only used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items. As used herein, the singular forms “a”, “an” and “the” are intended to include the plural forms as well, unless the context clearly indicates otherwise. It should be further understood that the terms “comprises,” “comprising,” “includes,” and/or “including” when used herein, specify the presence of stated features, operations, elements, and/or components, but do not preclude the presence or addition of one or more other features, operations, elements, components, and/or groups thereof.

When an element is referred to as being “on” another element, it can be directly on the other element or intervening elements may also be present. In contrast, when an element is referred to as being “directly on” another element, there are no intervening elements present. When an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Aspects and elements of all of the embodiments disclosed above can be combined in any way and/or combination with aspects or elements of other embodiments to provide a plurality of additional embodiments. Although a few exemplary embodiments of the inventive concepts have been described, those skilled in the art will readily appreciate that many modifications are possible in the exemplary embodiments without materially departing from the novel teachings and advantages of the inventive concepts provided herein. Accordingly, all such modifications are intended to be included within the scope of the present application as defined in the claims.

1. A charging apparatus configured to transfer energy via inductive coupling to an on-board power reception coil of a vehicle, the charging apparatus comprising:
a plurality of power transfer coils; and
a controller, configured to:
detect a presence of the vehicle in a proximity of the charging apparatus;
identify a power transfer coil from the plurality of power transfer coils to activate based on a position of the vehicle relative to the charging apparatus; and
activate the identified power transfer coil.

2. The charging apparatus of claim 1, wherein the controller is configured to identify a power transfer coil from the plurality of power transfer coils to activate based on an activation of each power transfer coil of the plurality of coils of the charging apparatus in a sequence and based on feedback indicating characteristics of an energy transfer resulting from the activation of each power transfer coil in the sequence.

3. The charging apparatus of claim 1, further comprising a plurality of sets of alignment coils, each set of alignment coils associated with a respective one of the plurality of power transfer coils, wherein the controller is configured to identify a power transfer coil from the plurality of power transfer coils to activate based on a detection of alignment signals by each of the alignment coils.

4. The charging apparatus of claim 1, wherein the controller is configured to detect the presence of the vehicle in the proximity of the charging apparatus based on a signal received from a positioning device.

5. The charging apparatus of claim 1, wherein the controller is configured to detect the presence of the vehicle in the proximity of the charging apparatus based on a signal received from a component of the vehicle.

6. The charging apparatus of claim 5, wherein the signal received from the component of the vehicle is a signal acknowledging an identification signal transmitted by the charging apparatus.

7. The charging apparatus of claim 1, wherein a center of each of the plurality of power transfer coils is offset from a center of a housing of the charging apparatus.

8. The charging apparatus of claim 1, wherein a housing of the charging apparatus is or resembles a parking bumper.

9. A charging apparatus configured to transfer energy via inductive coupling to an on-board coil of a vehicle, the charging apparatus comprising:
a power transfer coil;
a plurality of alignment coils; and
a controller, configured to:
detect a presence of the vehicle in a proximity of the charging apparatus;
detect signals received by each of the plurality of alignment coils; and
determine whether the vehicle is aligned or is not aligned relative to the power transfer coil based on the signals received by each of the plurality of alignment coils.

10. The charging apparatus of claim 9, wherein the controller is configured to detect the presence of the vehicle in the proximity of the charging apparatus based on a signal received from a component of the vehicle.

11. The charging apparatus of claim 10, wherein the signal received from the component of the vehicle is a signal acknowledging an identification signal transmitted by the charging apparatus.

12. The charging apparatus of claim 9, wherein the plurality of alignment coils comprises at least five alignment coils.

13. The charging apparatus of claim 12, wherein the controller is configured to determine whether the vehicle is aligned or is not aligned relative to the power transfer coil in a first axis and wherein the controller is configured to determine whether the vehicle is aligned or is not aligned relative to the power transfer coil in a second axis.

14. The charging apparatus of claim 9, wherein the controller is configured to determine whether the vehicle is aligned or is not aligned relative to the power transfer coil in one or more horizontal axes and wherein the controller is configured to determine whether an airgap between the vehicle and the power transfer coil is present in a vertical axis.

15. The charging apparatus of claim 9, wherein a housing of the charging apparatus is or resembles a parking bumper.

16. The charging apparatus of claim 9, wherein the power transfer coil is a first power transfer coil of a plurality of power transfer coils, wherein the plurality of alignment coils is a first plurality of alignment coils of multiple pluralities of alignment coils, each of the plurality of alignment coils associated with a respective one of the plurality of power transfer coils, wherein the controller is configured to identify an power transfer coil from the plurality of power transfer coils to activate based on a detection of alignment signals by each of the alignment coils of the multiple pluralities of alignment coils.

17. A charging apparatus comprising:
a power transfer coil configured to transfer energy to a power reception coil of a vehicle via a resonant signal;
a data reception coil configured to receive a communication signal from an on-board coil of the vehicle and the resonant signal from the power transfer coil; and
a data reception signal processing circuit configured to separate the communication signal from the resonant signal and provide the separated communication signal to a controller.

18. The charging apparatus of claim 17, wherein the data reception signal processing circuit comprises a band-pass filter, an envelope filter, and a low-pass filter.

19. The charging apparatus of claim 17, wherein the data reception signal processing circuit is configured to convert the communication signal from an analog signal to a digital signal.

20. The charging apparatus of claim 17, wherein the controller is configured to transmit a message to the on-board coil of the vehicle via a signal emission coil.
